(19) United States
(12) Patent Application Publication
(10) Pub. No.: US 2003/0094826 A1
(43) Pub. Date: May 22, 2003

(54) Retractable curtain for isolating driver's seat of recreational vehicle from remainder of vehicle

(75) Inventors: Scott P. Thompson, Longmont, CO (US); Christopher M. White, Frederick, CO (US); Garret Mauldin, Arvada, CO (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(73) Assignee: Carefree/Scott Fetzer Company, Broomfield, CO

(21) Appl. No.: 10/300,122

(22) Filed: Nov. 19, 2002

Related U.S. Application Data
(60) Provisional application No. 60/332,640, filed on Nov. 21, 2001.

(51) Int. Cl. B60P 3/05

(52) U.S. Cl. 296/24.1

(57) ABSTRACT

A retractable curtain system is mounted in the roof of a recreational vehicle and adapted to be extended downwardly across the width of the vehicle between a driver compartment and the remaining compartments of the vehicle, which are rearwardly of the driver compartment. The curtain is in the form of a pair of side-by-side barrier sheets that move up and down in unison while being wrapped around operatively connected roll bars, but define a slit or gap therebetween through which individuals can pass through the curtain even when it is extended.

### CROSS REFERENCE TO RELATED APPLICATION

This application claims priority to U.S. provisional application No. 60/332,640 filed Nov. 21, 2001, and the disclosure thereof is hereby incorporated by reference.

### BACKGROUND OF THE INVENTION

1. Field of the Invention

The present invention relates generally to a device for selectively separating the driving compartment of a recreational vehicle or the like from the remainder of the vehicle and more particularly relates to a retractable curtain system mounted in the ceiling of the vehicle and adapted to extend downwardly or be retracted adjacent to the top of the vehicle.

2. Description of the Relevant Art

The use of recreational vehicles and other such mobile vehicles is a popular means of vacation travel. Over time, both the size and the variety of amenities included in recreational vehicles have increased. Recreational vehicles generally have a forward or front cab that defines the driving compartment of the vehicle and rearwardly of the driver compartment are passenger compartments.

The passenger compartments include but are not limited to a living area or family room, a kitchenette, at least one bedroom and a bathroom. The rear passenger compartments often include many noise or light-emitting articles such as light(s), television(s), stereo system(s), kitchen equipment such as a microwave oven, and/or countertop appliances, and bathroom appliances. In addition, a single recreational vehicle may have multiple heaters and air conditioners or multiple heating and cooling zones to ensure that passengers riding in different areas of the vehicle are comfortable.

In recent times, driver distractions have been recognized as a significant cause of vehicle accidents. In a recreational vehicle, the presence of noise and light-emitting articles in the passenger compartments of the vehicle can become significant distractions to the operator or driver of the vehicle. There, accordingly, is a need for a system for isolating the driver and forward cab of the recreational vehicle from the rear passenger compartments.

Due to the fact that recreational vehicles are large in comparison to conventional passenger automobiles, as mentioned above they often include multiple heaters or multiple heating zones. During longer trips, passengers in the rear portions of a recreational vehicle often sleep while the driver of the vehicle continues to drive. Because the passengers in the rear of the vehicle are sleeping, they are able to cover themselves with blankets. However, the driver of the vehicle must continue to keep his or her feet clear of obstructions to safely operate the vehicle. Thus the heating requirements of the passengers in the rear portion of the recreational vehicle may be different from the heating requirements of the passengers in the forward cab of the recreational vehicle. Therefore, a system for isolating the forward cab of the vehicle from the rear compartments of the vehicle would be desirable for controlling the distribution of heat within the vehicle. The same is true with regard to cooling of the vehicle as frequently the driver of the vehicle will have different demands from a temperature standpoint than those in the rearward compartments of the vehicle and again it would be desirable to be able to control the distribution of cool air throughout the vehicle. Glare on the windshield created by lighting in the rear compartments is another hazardous condition created in recreational vehicles. For this reason also, a system for isolating the driving compartment from the rear compartments would be desirable.

It is to overcome the above problems existing in recreational vehicles that the present invention has been developed.

### BRIEF SUMMARY OF THE INVENTION

The present invention is directed to a retractable curtain mounted in the interior of a recreational vehicle or the like and adapted to provide a selectively moveable barrier between the driver's compartment of the vehicle and the compartments in the vehicle rearwardly of the driver's compartment.

In accordance with the present invention, a curtain is mounted in the ceiling or adjacent to the top of the recreational vehicle and is adapted to be extended downwardly, across the width of the vehicle, so as to establish a separation system effective against light, air temperature, noise and the like. The system is also designed to permit individuals to pass through the curtain even when the curtain is extended.

In the preferred embodiment of the present invention, the curtain is in the form of two side-by-side barrier components that extend and retract in unison, but provide an overlapping gap therebetween so that even when extended, an individual in the vehicle can pass through the curtain if desired.

The barrier components can be manually operated or motor driven and can be extended to any desired degree between the ceiling and the floor of the vehicle.

Other aspects, features and details of the present invention can be more completely understood by reference to the following detailed description of a preferred embodiment, taken in conjunction with the drawings and from the appended claims.

### BRIEF DESCRIPTION OF THE DRAWINGS

FIG. 1 is an isometric view of a recreational vehicle in which the retractable curtain of the present invention is installed.

FIG. 2 is a fragmentary side elevation taken along line 2-2 of FIG. 1 and with parts removed to show the retractable curtain of the present invention mounted in the ceiling of the recreational vehicle.

FIG. 3 is a fragmentary isometric of the retractable curtain of the present invention mounted in the ceiling of the recreational vehicle and with the curtain partially extended.

FIG. 4 is an exploded fragmentary isometric view showing the retractable curtain and a recess in the ceiling of a recreational vehicle in which the retractable curtain is mountable.

FIG. 5 is a fragmentary isometric similar to FIG. 4 with the retractable curtain inserted into the opening of FIG. 4.

FIG. 6 is a fragmentary isometric of the curtain of the present invention in a fully extended position.

FIG. 6A is an enlarged fragmentary section taken along line 6A-6A of FIG. 6.

FIG. 7 is a fragmentary isometric similar to FIG. 6 showing the side-by-side curtain components separated along the overlapping gap therebetween.

FIG. 8 is an isometric of the retractable curtain of the present invention looking downwardly on the top of the retractable curtain.

FIG. 9 is a section taken along line 9-9 of FIG. 8.

FIG. 10 is an enlarged section taken along line 10-10 of FIG. 8.

FIG. 11 is an enlarged section taken along line 11-11 of FIG. 8.

FIG. 12 is an enlarged section taken along line 12-12 of FIG. 9.

FIG. 12A is an enlarged section similar to FIG. 12 showing the brake system for the retractable curtain in an opposite position.

FIG. 13 is an enlarged section taken along line 13-13 of FIG. 9.

FIG. 14 is a section taken along line 14-14 of FIG. 13.

FIG. 15A is an exploded fragmentary isometric showing one end of the retractable curtain having the braking system therein.

FIG. 15B is an exploded fragmentary section showing components of the retractable curtain of the present invention adjacent one end thereof and on the inward side of a divider plate.

FIG. 15C is an exploded isometric similar to FIG. 15B showing the components of the retractable curtain on the opposite or outer side of the divider plate.

### DETAILED DESCRIPTION OF THE INVENTION

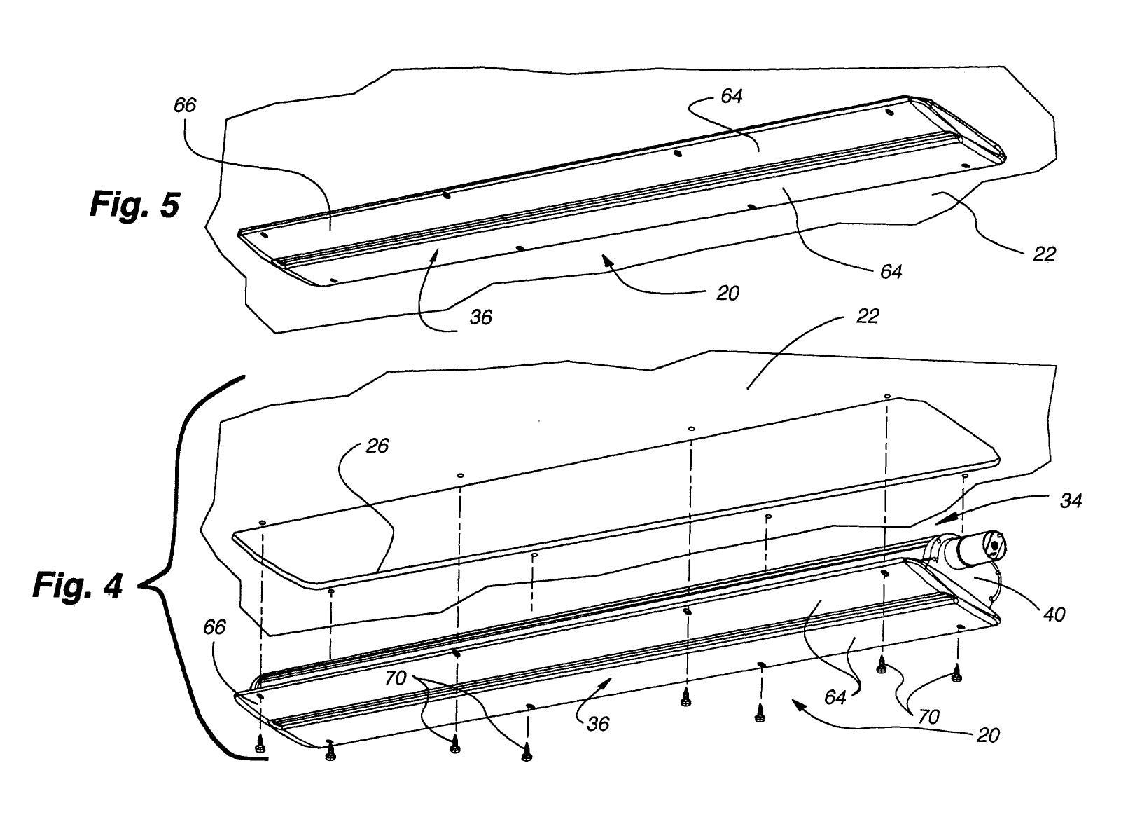

The retractable curtain 20 of the present invention as seen in FIGS. 2, 3, 4, 6, and 7 is adapted to be mounted in the hollow ceiling 22 of a recreational vehicle 24 and while it could be done in numerous manners, in the preferred embodiment, an opening 26 is established in the ceiling of the vehicle so the retractable curtain is recessed and does not, when retracted, significantly protrude into the interior of the vehicle.

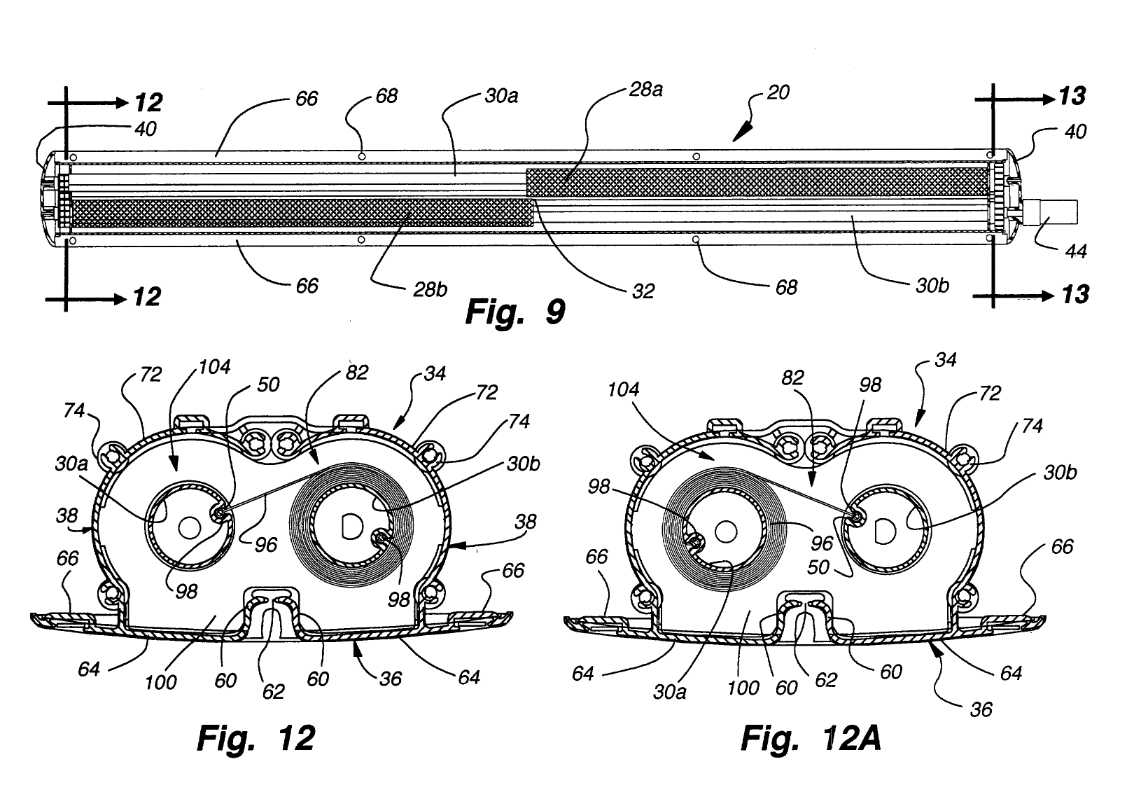

The retractable curtain 20 includes a pair of side-by-side barrier components 28a and 28b, which in the preferred embodiment, are sheets of opaque or translucent material which are adapted to be wrapped independently about separate roll bars 30a and 30b (FIGS. 9, 10, and 11) when the curtain is retracted. The barrier sheets are mounted in side-by-side relationship but overlap slightly along adjacent edges thereof so as to define a slit or gap 32 between the sheets through which an individual can pass if desired.

The roll bars 30a and 30b for the barrier sheet material are mounted in a housing 34 (FIGS. 8, 10, and 11) that is recessed within the ceiling 22 of the vehicle and the housing has a decorative lower surface plate 36 which is visible from the interior of the vehicle. The housing has two main component body parts 38 which are positioned in side-by-side relationship so as to define a small gap 39 therebetween through which the barrier sheet material 28a and 28b extends. End caps 40 are provided for holding the two main component body parts 38 in the desired spaced positions and for establishing bearings for rotatably supporting the ends of each of the roll bars 30a and 30b.

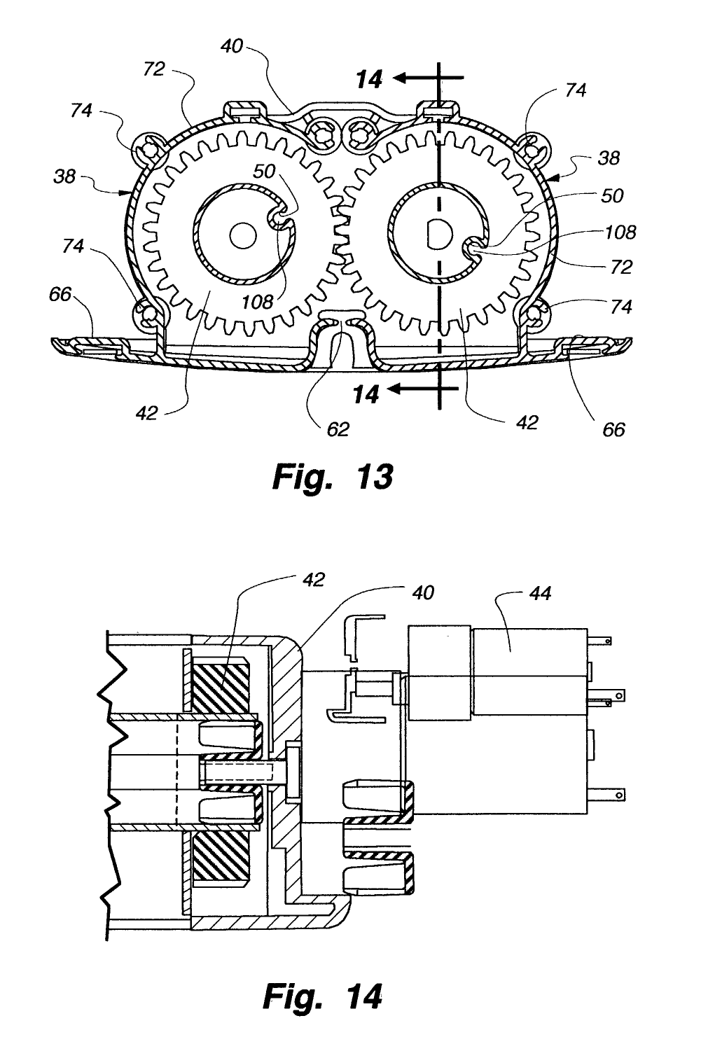

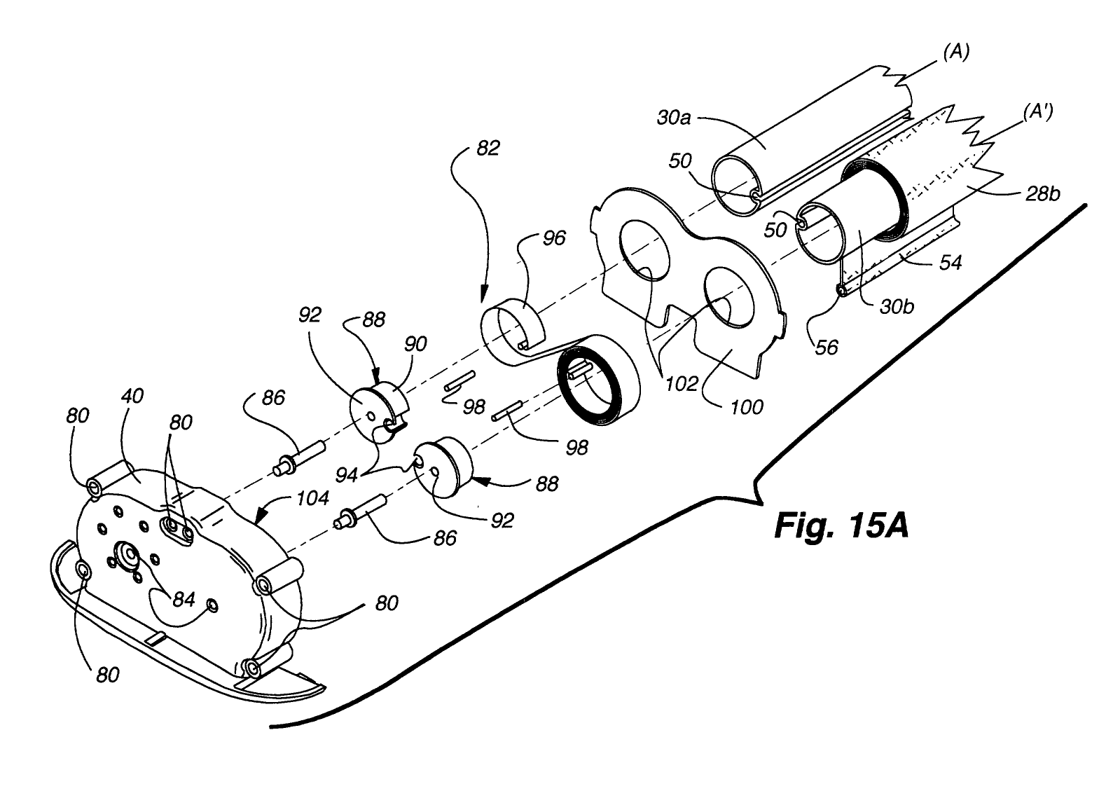

With reference to FIGS. 13 and 14, each roll bar 30a and 30b at a driven end thereof has a ring gear 42 keyed thereto with the ring gears of the adjacent roll bars being meshed so as to simultaneously rotate. In the preferred embodiment of the invention, a reversible motor 44 (FIG. 9) is provided for driving roll bar 30b in either direction which establishes a reverse direction of rotation in the other roll bar 30a through the ring gears.

As will be appreciated by reference to FIG. 9, each roll bar 30a and 30b extends the full length of the curtain system even though the barrier sheets 28a and 28b associated with each roll bar extend only slightly greater than half the length of the associated roll bar on which it is mounted. Of course, sheet 28a is mounted at one end of its associated roll bar and sheet 28b is mounted at the opposite end of its roll bar so the entire length of the curtain system is covered in aggregate by the two barrier sheets with a slight overlap along their adjacent edges.

The retractable curtain system of the invention is mounted immediately behind the driver's seat 46 (FIG. 2) of the vehicle thereby separating the driver's compartment 48 from the remaining interior of the vehicle when the curtain system is extended. The barrier sheets 28a and 28b are long enough to extend from the ceiling of the vehicle to the floor of the vehicle even though it will be appreciated the curtain could be selectively extended any desirable amount therebetween.

With particular reference to FIGS. 9, 10, 11, 12, 12A, and 15B, each roll bar 30a and 30b is of cylindrical configuration having an elongated groove 50 of C-shaped cross section in its outer peripheral surface for selectively securing an edge 52 of a barrier sheet 28a or 28b as will be described hereafter. Each roll bar is conventionally journaled in an end cap 40 with one associated end of each roll bar, as mentioned previously, having one of the ring gears 42 mounted thereon and keyed thereto for unitary rotation therewith. The lateral spacing of the roll bars is predetermined to accommodate the size of the ring gears so they desirably mesh as illustrated in FIG. 13.

The barrier sheets 28a and 28b are flexible sheets of any desirable material such as vinyl, fabric or the like. The sheets of barrier material are rectangular in configuration having the upper edge 52 secured to an associated roll bar and a lower edge 54 having a hem therein that receives a weighted rod 56 so the barrier sheets desirably hang from the roll bars by gravity. The upper edge 52 of each barrier sheet also has a hem therein which is inserted into the elongated groove 50 in the roll bar prior to receiving an anchor rod 58 with the anchor rod being large enough to prevent the edge of the barrier sheet from being removed from the groove.

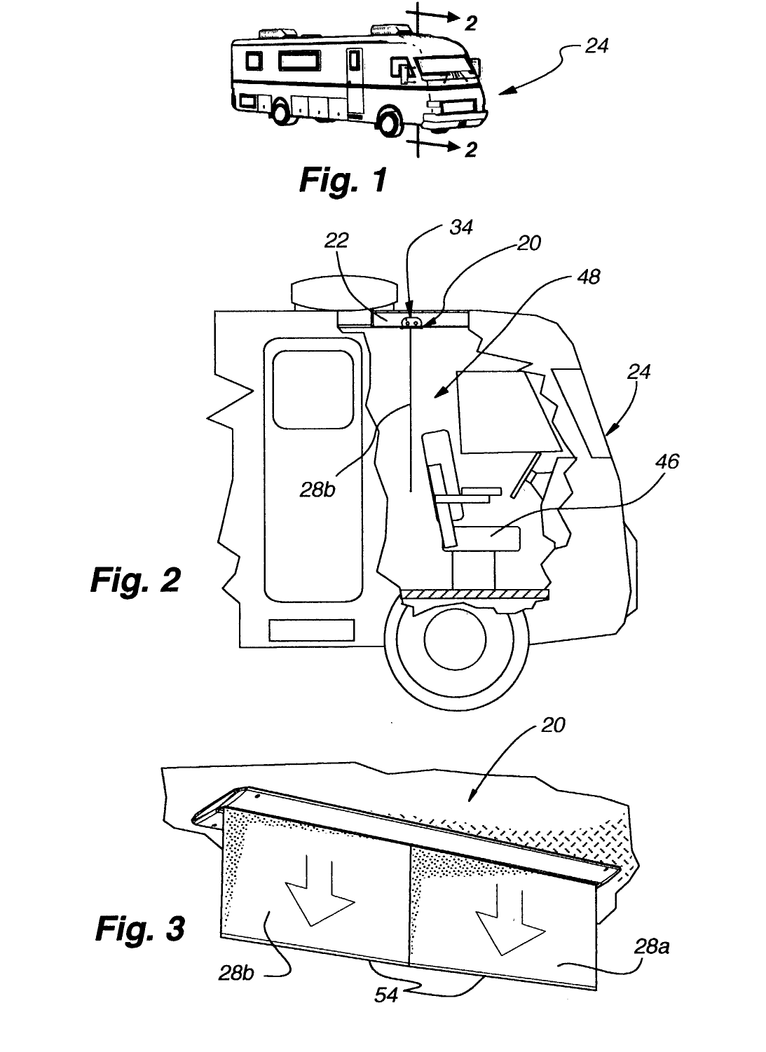

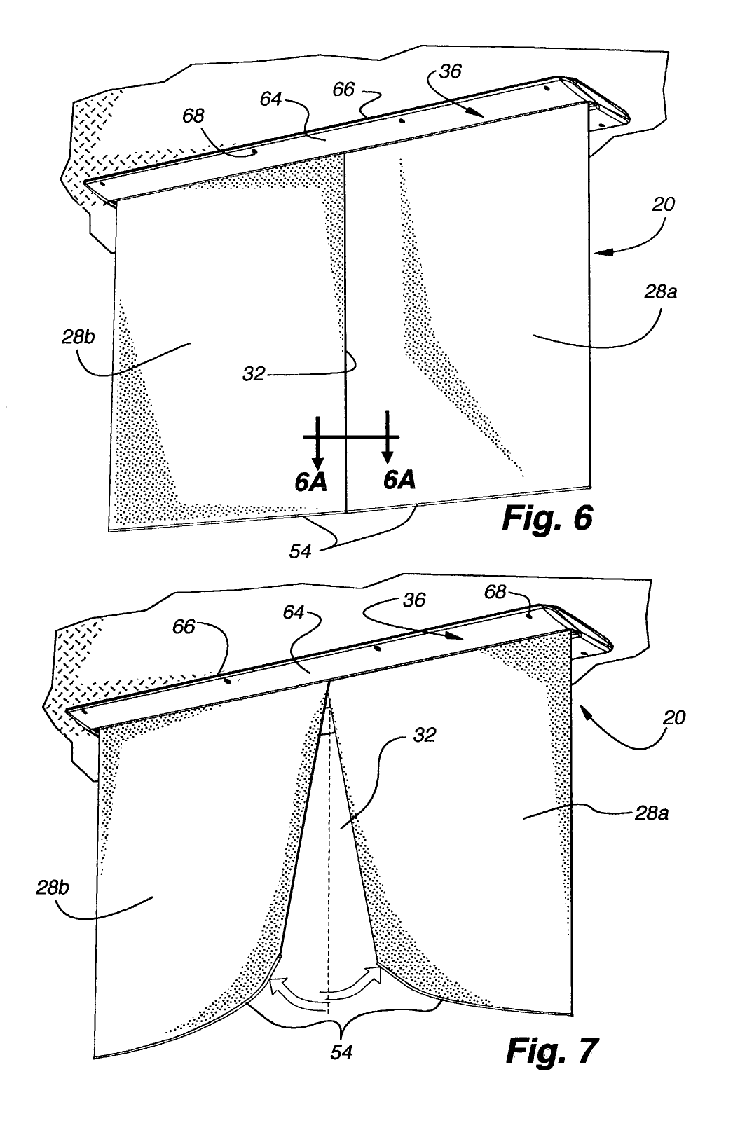

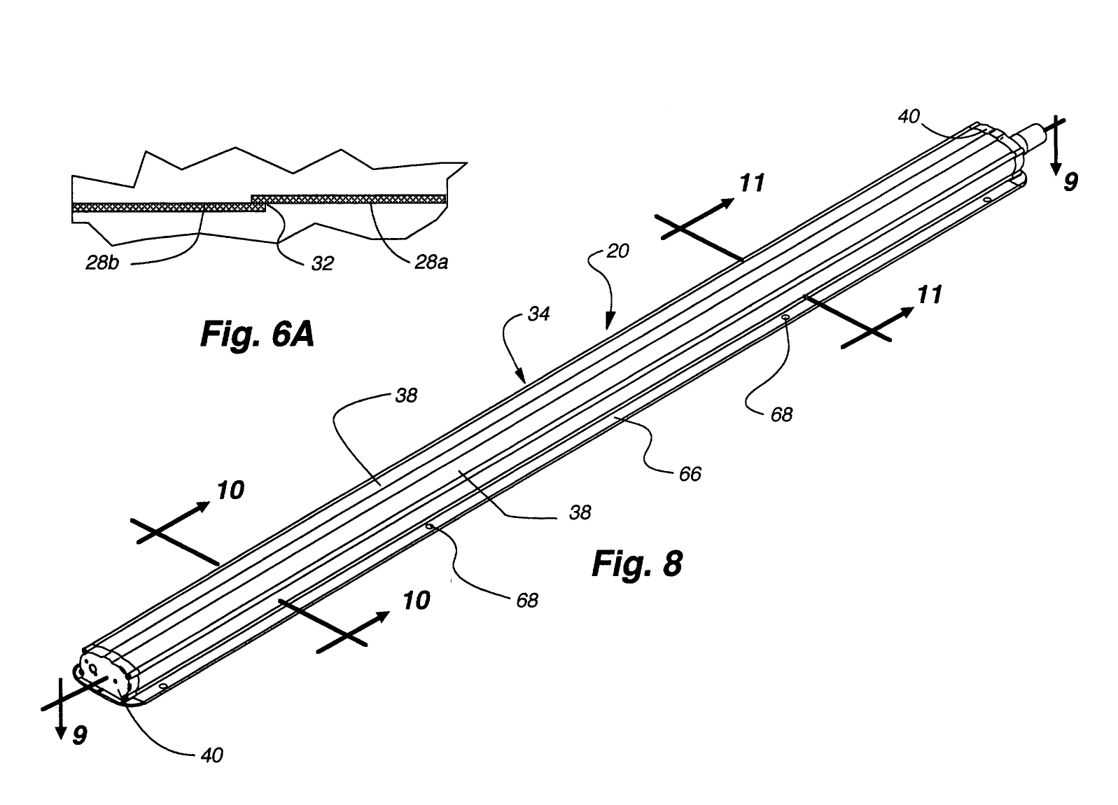

As seen in FIG. 1, the barrier sheets 28a and 28b are wrapped in reverse directions around their associated roll bars 30a and 30b respectively and have their weighted free or lower edges 54 extending downwardly through the gap 39 between the component body parts 38 of the housing. Since the barrier sheets overlap slightly along their adjacent vertical edges, as seen in FIG. 6A, one sheet 28b is positioned slightly forwardly of the other sheet 28a with the forwardmost sheet 28b being secured to the forwardmost roll bar 30b of the pair of roll bars.

The housing component body parts 38, adjacent to the gap 39 therebetween, have upwardly extending serpentine edges 60 which together define a downwardly opening recess 62 in which the lower weighted edges 54 of the barrier sheets can be disposed when the curtain is fully retracted. As mentioned previously, when the forwardmost roll bar 30b is rotated in a predetermined direction, i.e. clockwise as viewed in FIG. 11, the barrier sheet 28b mounted thereon is caused to unwrap from the roll bar. Clockwise rotation of the forwardmost roll bar, due to the ring gears 42, causes a counterclockwise rotation of the rearwardmost roll bar 30a which causes the barrier sheet 28a wound thereon to also unroll due to the fact that it is wound on its roll bar in a reverse direction from that of the forwardmost barrier sheet. Of course, driving the motor 44 in the reverse direction causes the barrier sheets to retract causing the sheets to wind about their associated roll bars.

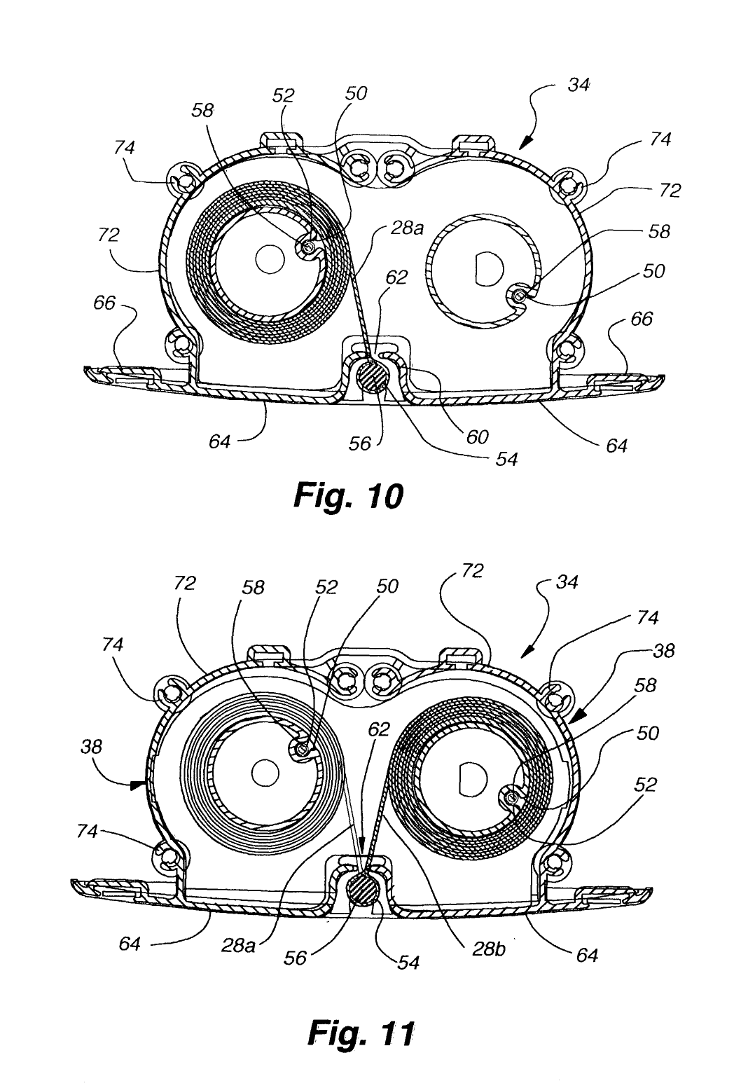

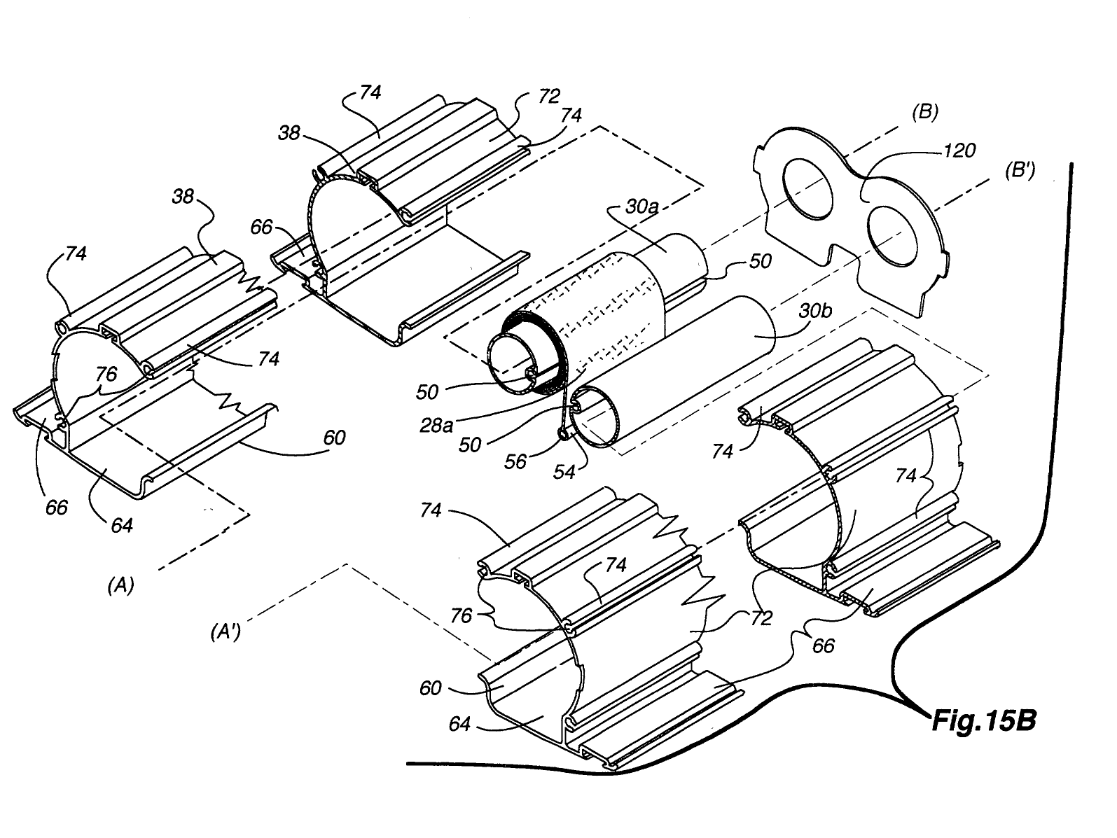

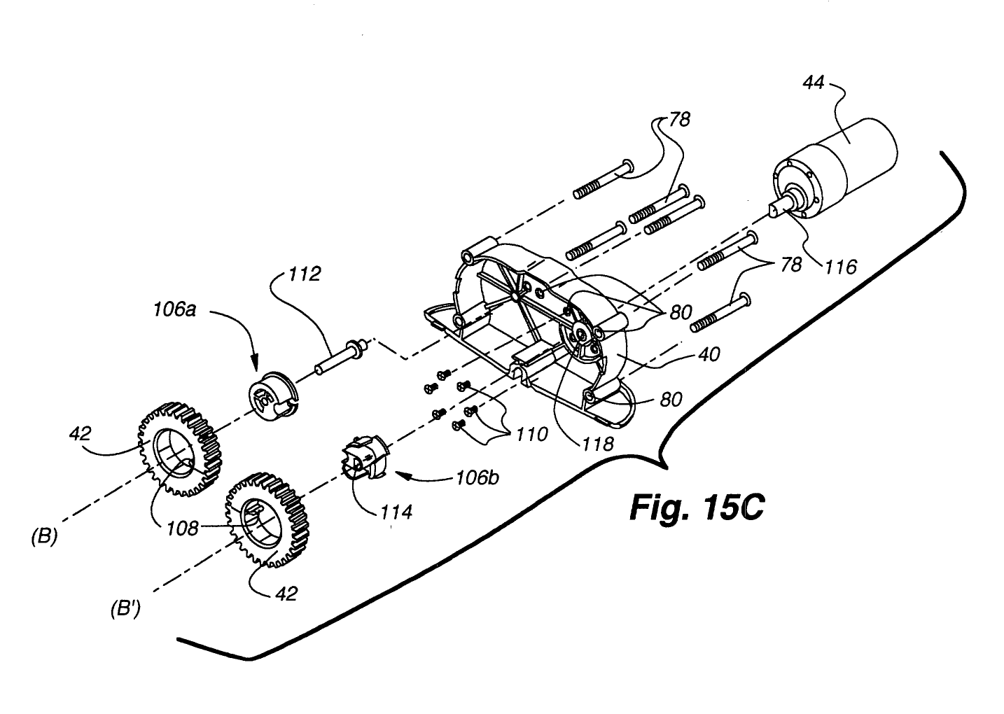

With reference to FIGS. 10-12 and 15b, it will be seen that each housing component body part 38 is the mirror image of the other and includes its one-half portion of the decorative lower surface plate 36 that is visible from the interior of the vehicle. Surface plates 64 on each body part 38 define the gap 39 therebetween through which the barrier sheets 28a and 28b extend. Along an opposite lateral edge of the surface plates 64, a flange 66 is defined through which a plurality of openings 68 are provided to receive screw-type fasteners 70 to secure the respective housing component body parts to the ceiling 22 of the recreational vehicle along the edges of the opening 26 provided in the ceiling for receipt of the retractable curtain 20. Each housing component body part 38 further has a semicylindrical body portion 72 which extends upwardly and partially around an associated roll bar with the semicylindrical body portion having three outwardly directed longitudinally extending channels 74 of C-shaped cross section which define openings 76 at opposite ends of each housing component body part into which screw-type fasteners 78 (FIG. 15C) passing through an end cap 40 can be anchored. In other words, as seen in FIG. 15C, the end caps have six openings 80 therethrough in which the screw-type fasteners 78 can be inserted and threadedly received in the open ends 76 of the channels 74 provided in the outer surface of the housing component body parts. In this manner, the housing components can be rigidly held together in a desired spacing from each other. The motor 44 is mounted on the outside of one end cap in driving engagement with an end of the rearwardmost roll bar 30a as will be described later. Of course, the forwardmost roll bar is merely mounted on bearings at opposite ends and turns in unison with the rearwardmost roll bar but in a reverse direction.

A reversible motor 44 of the type employed in the retractable curtain will shut down or be de-energized in a conventional manner when prevented from rotation in either direction. Accordingly, a braking system 82 is employed in the retractable awning at the opposite end of the awning from the motor to prevent further rotation of the roll bars at each extreme of the curtains' movement thereby forcing the motor to shut down. With reference to FIGS. 12, 12A, and 15A, the braking system can be seen mounted within the end cap 40 at the associated end of the retractable curtain.

The end cap 40 receiving the braking system has a pair of passages 84 therethrough axially aligned with each roll bar 30a and 30b with each passage receiving a support pin or shaft 86 on which anchor caps 88 are rotatably mounted. Each anchor cap has a cylindrical body 90 with an enlarged plate 92 at one end and an axially extending groove 94 extending therethrough adjacent to and interiorly of the cylindrical body 90. The groove 94 is adapted to slidably receive the inwardly protruding wall of the elongated groove 50 of the associated roll bar so the anchor cap becomes keyed to the roll bar and rotates in unison therewith about the support pin 86. An elongated flexible, but non-extensible tape 96, which could be made of fabric, metal, plastic, or the like, is connected to the two anchor caps so as to extend between the caps and be wrapped around the caps in reverse directions. Each end of the tape has an anchor pin 98 secured in a hem therein with the anchor pin being adapted to be received in the open end of the groove 50 in the associated roll bar. It will therefore be appreciated that each end of the tape rotates in unison with its associated roll bar and anchor cap and as the roll bars rotate in reverse directions relative to each other, the brake tape 96 is wrapped around one roll bar as it is unwrapped from the opposite roll bar. When the tape becomes fully wrapped on one roll bar and fully unwrapped from the other, as shown in FIGS. 12 and 12A, the tape prevents the roll bars from further rotating and thereby de-energizes the motor. The motor is energized in reverse directions with a three-position toggle switch (not shown) but the braking system automatically shuts the motor down when the curtains are fully retracted or fully extended. Of course, the toggle switch can be used to de-energize the motor at any position of the barrier sheets between their fully retracted and extended positions. A flat divider plate 100 having two large openings 102 therethrough adapted to receive the associated ends of the roll bars 30a and 30b is positioned between the braking tape 96 and the barrier sheets 28a and 28b on the roll bars to maintain a separation so as to avoid interference during operation of the retractable curtain.

With reference to FIGS. 15B and 15C, the end of the retractable curtain with the motor 44 is illustrated in exploded views. With first reference to FIGS. 15C, it will be appreciated the end cap 40 is a mirror image of the end cap 40 at the opposite end of the retractable curtain. Accordingly, the end cap establishes or defines a cavity 104 in which the ring gears 42 can be mounted in meshed relationship with each other and mounted on the roll bars for unitary rotation therewith. Each ring gear will be seen to have an inwardly protruding spline 108 received in the groove 50 of the associated roll bar so the roll bars and ring gears rotate in unison with each other. A bearing 106a is provided to support the associated end of the roll bar 30a and is seated on a support pin or shaft 112 in the end cap to rotate freely within the end cap while another bearing 106b has a D-shaped central axial passage 114 adapted to receive the D-shaped drive shaft 116 of the motor 44. The motor is secured to the end cap 40 with fasteners 110 such that its drive shaft protrudes through an opening 118 in the end cap and is received in the associated bearing 106b which sits within its associated roll bar and within the cavity 104 defined in the end cap. It will therefore be appreciated that when the motor is energized to rotate in one direction or another, the bearing 106b associated therewith rotates causing the externally mounted ring gear 42 to rotate via the roll bar 30b which in turn causes the meshed ring gear on the other roll bar 30a to rotate in an opposite direction on its bearing.

Looking at FIG. 15B, it will be seen that a plate-like divider 120 is provided at the motor end of the retractable curtain that is identical to the divider plate 100 at the opposite end of the retractable curtain. The divider plate 120, therefore, separates the ring gears 42 from the barrier sheets mounted on the roll bars associated with the ring gears. The bearings 106a and 106b for each roll bar protrude into the open end of the associated roll bar and are keyed thereto for rotation therewith. The bearings protrude through the divider plate 120 and into the open end of the roll bars where an outer axial groove in each of the bearings receives the inwardly protruding surface defined by the elongated groove 50 in the roll bar.

It will be appreciated from the above description that a retractable curtain for use in recreational vehicles or the like has been described which can be attractively mounted in the vehicle in an out-of-the-way location, i.e. recessed within the ceiling of the vehicle, and is selectively operable to raise or lower barrier sheets that shield the driver's compartment from light, noise, air currents, and the like. Along adjacent edges of the barrier sheets, a slit or gap is defined through which an individual can pass between the two sheets so as to move between the driver compartment and the other compartments of the vehicle rearwardly of the driver compartment.

Obviously, there are many variations to the embodiment described above and by way of example, the barrier components could in fact be venetian-blind type barriers (not shown) which would be lifted and stacked adjacent to the top of the vehicle rather than being rolled on roll bars. Conventional lift systems for venetian blind-type barrier components are well known in the art and would replace the roll bars described herein. Similarly, the lower edge of the barrier sheets described above could receive a common weighted rod so the lower or free edges of the barrier sheets were integrated in this manner while still leaving a slit or gap between the sheets even though passage between the sheets is easier when the barrier sheet components are allowed to remain separated along their lower edge.

Even though the present invention has been described with a certain degree of particularly, it is understood the present disclosure has been made by way of example, and changes in detail or structure may be made without departing from the spirit of the invention as defined in the appended claims.

What is claimed is:

1. A motorized vehicle having in combination:
a vehicle body with a front end, a rear end, left and right sides, and a top,
seating adjacent to the front end of the vehicle for an operator of the vehicle, and
an adjustable curtain suspended from said top of the vehicle at a location rearwardly of said seating, said curtain having a barrier component being moveable between a retracted position adjacent to said top of the vehicle and an extended position hanging downwardly from said top of the vehicle, said barrier component being divided along a vertical slit between left and right portions, said slit providing a passage through which individuals can pass through the barrier component.

2. The vehicle of claim 1 wherein said left and right portions of said barrier component are individual barrier components.

3. The vehicle of claim 1 wherein said barrier component is one or more sheet-like materials.

4. The vehicle of claim 2 further including a roll bar associated with each sheet-like material.

5. The vehicle of claim 4 wherein each sheet-like material has an adjacent edge that overlap the adjacent edge of the other sheet-like material.

6. The vehicle of claim 4 wherein said roll bars are operatively interconnected such that rotation of one roll bar effects a corresponding rotation of the other roll bar.

7. The vehicle of claim 6 wherein said roll bars are mounted in adjacent parallel relationship.

8. The vehicle of claim 7 wherein said sheet-like materials are wrapped in reverse directions around the respective roll bars such that the sheets unroll from the respective roll bars in closely adjacent relationship.

9. The vehicle of claim 8 wherein said roll bars simultaneously rotate in opposite directions.

10. The vehicle of claim 5 wherein the vehicle further includes a floor and wherein said sheet-like material extends to said floor when the sheet-like portions are fully extended.

11. The vehicle of claim 4 further including a motor for selectively rotating said roll bars.

12. The vehicle of claim 1 wherein said barrier components comprises at least one venetian blind.
